(19) United States
(12) Patent Application Publication
(10) Pub. No.: US 2003/0037261 A1
(43) Pub. Date: Feb. 20, 2003

(54) Secured content delivery system and method

(75) Inventors: Gregory Meffert, Gonzales, LA (US); Paul Hastings, River Ridge, LA (US); Doug Laine, New Orleans, LA (US); Mark C. Kurt, New Orleans, LA (US)

Correspondence Address: Gardner, Carton & Douglas, Suite 3400, 321 North Clark Street, Chicago, IL, 60610-4795, US

(73) Assignee: iLumin Corporation, Reston, VA (US)

(21) Appl. No.: 10/136,233

(22) Filed: May 1, 2002

Related U.S. Application Data
(63) Continuation-in-part of application No. 09/816,255, filed on Mar. 26, 2001.
(60) Provisional application No. 60/287,416, filed on May 1, 2001.

(51) Int. Cl. H04L 9/00

(52) U.S. Cl. 713/201; 713/156

(57) ABSTRACT

Systems and Methods for secured content delivery between a sender and a recipient in an electronic network using PKI-based encryption. The system includes a sender local agent associated with a sender electronic device and a recipient two-factor authentication associated with a recipient wireless device wherein both the devices are capable of connecting to a control server via the Internet. The sender local agent is operable to (i) receive content generated on the sender electronic device, (ii) generate a package of encrypted content using PKI-based encryption by obtaining at least one public key from the control server, and (iii) send the package to the control server. The control server is operable to receive the package from the sender local agent and transmit the package to the recipient local agent. The recipient two-factor authentication is operable to (i) receive the packet from the control server, (ii) prompt the recipient to enter a user PIN, (iii) responsive to receiving the user PIN, generate a one-time passcode that is valid within a predetermined interval, and (iv) accessing to the network within the predetermined interval using both the user PIN and the one-time passcode.

### RELATED APPLICATIONS

This application claims priority to U.S. provisional patent application Serial No. 60/287,416 entitled, SECURED CONTENT DELIVERY SYSTEM AND METHOD, filed May 01, 2001 by Meffert, et al., herein incorporated by reference in its entirety.

In addition, this application claims the benefit of pending U.S. patent application Ser. No. 09/816,255 entitled, SECURED DOCUMENT DELIVERY SYSTEM, filed Mar. 26, 2001 by Meffert, et al., herein incorporated by reference in its entirety, which claims priority to 60/200,378.

### FIELD OF THE INVENTION

The present invention relates to communications in an electronic network. More specifically, it relates to a secured content delivery system and method for securing, authenticating and controlling digital communications, content and transactions including streaming communications using public key infrastructure (PKI) based encryption.

### BACKGROUND OF THE INVENTION

One of the challenges of the Internet, whether for transmitting sensitive email (with or without attachments), for conducting electronic commerce, for implementing bill presentment schemes or for carrying out content publishing, is the risk of having the documents or electronic/digital content fall into the wrong hands, or be used in an unauthorized way. While the use of the Internet for the uses mentioned above has been growing steadily over the last few years, one major obstacle to truly explosive growth is the lack of actual or even perceived security. For example, attorneys are reluctant to send sensitive documents over the Internet as email attachments as they could be intercepted. Likewise, consumers are hesitant to purchase items over the Internet using credit cards as these numbers could be diverted and used fraudulently. Additionally, magazine publishers, recording companies and content producers in general have failed to fully exploit the leverage the Internet provides because once the content is published over the Internet it is available in digital form and easily copies without the knowledge (or permission) of the author or publisher, thereby depriving the content producer of revenue. The idea of protecting digital content that is transmitted over an electronic network or is otherwise convey electronically from one party to another is often referred to as “digital rights management” or DRM. Unfortunately, widely accepted DRM standards have yet to be adopted by the public at large and the potential of the Internet as a content distribution medium has yet to be fully attained.

In addition to the desire to secure documents and content that are transmitted via the Internet, there is also a need for identity authentication. In the physical world, photo Ids and handwritten signatures are used to ensure that a person is who he or she claims to be. The Internet, however, is a relatively anonymous world, making it hard to know who is at the end of a network connection. To address the foregoing issues, namely, content security and identity authentication, various methods have been devised including digital signature and encryption techniques. Known methods of encryption offer different advantages and disadvantages such as the speed of the encryption and decryption process and how safe the encryption actually is.

For example, though not originally designed for Internet use, electronic data interchange (EDI) was developed to provided computer-to-computer exchange of business documents between companies. In some implementations, hand shaking protocols and encryption are used to confirm that the sender and recipient are indeed who they allege to be. EDI is now used extensively over the Internet. Unfortunately, for the casual Internet user or a user that is not concerned with purchase orders, shipping documents, invoices and invoice payments (document types for which EDI was originally developed), the protocols that are used for EDI are not particularly useful. More importantly both the sender and recipient must have computers and software that understand the unique EDI protocols to communicate via EDI.

Another means to increase authentication and security of digital data over electronic networks and establish identity authentication is public/private key infrastructure (PKI). PKI is a global, de-facto standard that uses symmetric and asymmetric encryption and digital certificate to achieve secure Internet services. In practice, PKI systems use a matching pair of encryption and decryption keys. A “public” key is available and known to everyone, while a “private” key is secret—and accessible only by the user. In a PKI system, a certificate authority (CA), a widely trusted organization established to assure trust, issues electronic credentials called digital certificates, using a standard such as the International Telecommunications Union (ITU) standard X.509. With the electronic digital certificate, the user and his public key are identified, much like a photo ID in the physical world. The two keys combined—along with a digital signature—offer undeniable proof of the sender's identity, and the fact that the document has been delivered unaltered. Combining the concept of a digital certificate with PKI keys results in an infrastructure for electronic identification, and secure electronic communication (for business or any other use). Unfortunately, implementation of PKI systems like that just described is usually a very expensive proposition and presently is undertaken only by relatively large corporations that are able to afford it.

A common implementation of PKI, for example, employs Rivest-Shamir-Aldeman (RSA) and Data Encryption Standard (DES) encryption.

RSA capitalizes on the relative ease of creating a composite number from the product of two prime numbers whereas the attempt to factor the composite number into its constituent primes is difficult. Pairs of public/private keys can then be found based on the factors of the composite number. A message is encrypted using a series of mathematical exponentiations and divisions based on one of the keys. If the matching key of the public/private key pair is know, the message can be decrypted using a series of mathematical exponentiations and divisions using the matching key. The composite number is a part of public and private keys so it is known to the public. However, since the private key can only be found by factoring the composite number, calculating the private key from the public key is computationally difficult.

The security of the RSA technique can be enhanced by increasing the difficulty of factoring the composite number through judicious choices of the prime numbers. (This, of course would be true for any encryption/decryption scheme using or requiring prime numbers.) Another, and principle enhancement, is to increase the length (i.e., size) of the composite number. Today, it is common to find RSA schemes being proposed in which the composite number is on the order of 600 digits long. The task of exponentiating a number this long, however, can be daunting and time consuming, although not as difficult as factoring. Therefore, increasing the length of the composite number increases the security, but only at the expense of increased time to perform the encryption and decryption. The RSA scheme is described in U.S. Pat. No. 4,405,829, herein incorporated by reference in its entirety.

Pretty Good Privacy, commonly known as “PGP”, is a “Stripped-down” version of a PKI system and has become popular even among some casual users of the Internet. The benefit of PGP is that while it is relatively easy for a single user to set up, it still provides the user with one of the best encryption schemes available, namely, public/private key encryption. PGP is primarily designed to secure e-mail and to digitally sign documents and probably the most common encryption program in use due to its ease of implementation and the fact that no explicit infrastructure is required. While PGP is easily setup compared to a traditional PKI model that a large corporation might implement, PGP can sometimes be awkward to use and, more importantly, is less robust when it comes to issues like digital certificate creation, management, automated key issuance and retrieval, authentication and trust. Specifically, in PGP there are no certificates, CAs, or strong authentication. Thus, PGP is only a limited solution to security issues on the Internet.

Web browsers operating in conjunction with the World Wide Web also offer a level of security embodied in Secure Socket Layer (SSL). SSL is an Internet protocol that encrypts all of the communications between a web site and a client. This method of making a web site secure uses multiple methods of encryption and relies on certificates to authenticate a web site's identity. For these reasons, and the ease by which SSL can be implemented, SSL is the encryption protocol currently used to encrypt Internet credit card transactions.

Another example of the use of SSL is described in U.S. Pat. No. 5,790,790, herein incorporated by reference in its entirety, which discloses a system for delivery an electronic document using HTTP to “push” a document to a remote server. The remote server, upon receipt of the document, notifies an intended recipient of the document that the document has been received and that the recipient can then download the document using local protocols. Because, in accordance with the '790 patent, the document is being transmitted using HTTP, SSL is implemented to achieve a minimum level of security.

Among the various methods of document security and identity authentication, EDI and full-scale PKI can be considered the most robust EDI and full-scale PKI are, however, generally difficult to use and implement. Conversely, smaller scale encryption systems such as PGP and web-based security schemes like SSL may be more simple to implement, but these smaller scale encryption systems cannot offer the level of security or identity authentication that the more robust PKI systems can. Thus, there continues to be a need for systems and methods that provide robust security and identity authentication with respect to content delivered over the Internet while, at the same time, being relatively simply to use.

Moreover, there is still a need for a system and method for secure digital rights management. In particular, there continues to be a need for establishing security and control over electronic content that is intended to be published over the Internet in order to maintain valuable rights in the content.

Further still there remains a need for simple and secure bill presentment systems and methods so that vendors and service providers can replace conventional bill mailings with an electronic system that is accurate and secure.

It is therefore desirable to improve the security for delivering content information between the sender and recipient in electronic networks so that the content information cannot be misused, misdelivered or misappropriated by rouge user.

### SUMMARY OF THE INVENTION

In accordance with an illustrative embodiment of the present invention, the problems associated with delivering secured content are overcome. A system and method for secured content delivery is provided.

It is an object of the present invention to provide a simple and robust implementation of PKI encryption with no or little intervention by a user.

It is also an object of the present invention to provide an implementation of PKI-based encryption that separates, functionally, local or front end functions and server side or back end functions.

It is still a further object of the present invention to provide an implementation of PKI-based encryption in which local and back end portions of the encryption system automatically communicate with one another without user intervention.

It is an object of the present invention to provide a system and method of PKI-based encryption that operates with existing email client applications.

It is also an object of the present invention to provide encryption and control for the life of content that is encrypted in accordance with the principles of the present invention.

It is also an object of the present invention to provide a system and method for effecting, in online and offline environments, full digital rights management with respect to any content that is in electronic form and is conveyed via the Internet.

It is also an object of the present invention to provide a system and method for providing security and authentication among businesses, and in particular application-to-application securing and authenticating.

It is still a further object of the present invention to provide a system and method of PKI-based encryption in which keys are automatically transferred to a party, device or system requiring such keys.

It is also an object of the present invention to provide a system and method for delivering electronic content from a sender to a recipient using the Internet, wherein the recipient is notified that content is awaiting pickup using a notification means other than the Internet.

It is yet another object of the present invention to provide a system and method that permits a sender of content to establish content viewing privileges that cannot be altered by the viewer.

It is also an object of the present invention to provide a system and method of PKI-based encryption in which content that is delivered to a recipient remains in an pa encrypted state except when viewing or otherwise using the content for its intended purpose.

It is also an object of the present invention to provide a system and method of PKI-based encryption in which a control server controls the passing of content between sender and recipient and/or controls the viewing or use of content by a recipient.

It is also an object of the present invention to provide a system and method of PKI-based encryption in which a local agent, in conjunction with an application specific interface, stores private and public keys that are used to view or use content.

It is still a further object of the present invention to provide a system and method in which content that is transmitted from a sender includes permanent embedding of user access, distribution rights and transaction history.

It is also an object of the present invention to provide a system and method that effects PKI-based encryption that includes a local agent that is operating system independent and can communicate with a control server that is accessed via the Internet.

It is also an object of the present invention to provide a PKI-based encryption system and method that automates identity authentication.

It is also an object of the present invention to provide a system and method of receiving encrypted content that is decrypted within an environment controlled by an applet.

It is also an object of the present invention to provide a system and method of PKI-based encryption in which a one-time passcode is generated to recipient remains in an encrypted state.

Objects of the present invention include the provision of providing an Internet-based PKI-based encryption system and method that sends data such as documents, email, music files, XML content, etc., (hereinafter “content”) easily and securely, with the minimum possible user intervention. In accordance with an important aspect of the present invention, the system provides life-of-content security, i.e., the system controls use of the content even after it has been sent or conveyed, with a full menu of restrictions including, for example, “do-not-print-or-forward” and “self-destruct”. Accordingly, even if a computer or device on which the content is stored were stolen or fell into the wrong hands for even a limited amount if time, the content that has been encrypted in accordance with the present invention remains secure and readable only by the intended recipient. In the following description a “recipient” is meant to include anything that receives content. Thus, a person as well as electronic devices and electronic processes are considered recipients with the context of the present invention.

In accordance with the present invention, a full PKI-based encryption system is implemented within a company network, or hosted by one or more servers accessible via the Internet. Specifically, a user can join a Certificate Authority (CA) managed by the present invention, which is implemented as a global trusted hierarchy, or, a user can associate, or cross-certify, his existing PKI environment via, for example, linked Lightweight Directory Access Protocol (LDAP) directories, such that the existing Certificate Authority (CA) and PKI environment becomes a trusted entity within the PKI environment of the present invention.

Still further in accordance with the present invention, all aspects of PKI management are preferably performed on behalf of the user without, or with very little, user intervention. More specifically, identity authentication, certificate issuance, key generation (when needed) and certificate revocation list (CRL) management and recycling are all accomplished, substantially automatically, by the present invention. In addition, the present invention provides a certificate repository, certificate revocation, key backup and recovery (e.g., in case a user forgets his or her password), support for non-repudiation of digital signatures, management of key histories, and support for cross-certification. More specifically, carious interrelated components of the present invention are provided to generate symmetric keys, authenticate identities (digital signature authentication), implement audit logging, in concert with a certificate management service that provides certificate issuance, revocation, and recovery. In addition, a local agent can retrieve appropriate private and public keys from different CA's simultaneously to automate cross-certification.

In accordance with the present invention, access and protection of content stays firmly under the control of the user (sender or recipient, as the case may be), for the life of the content. Once encrypted, the content stays secure, e.g. encrypted, for its entire “life” and since, in accordance with the present invention, only the recipient of the content has the appropriate key, only the recipient can gain access to that content to the extent permitted by the party that conveyed the content to the recipient in the first place.

In an important aspect of the present invention, the PKI and either the provided CA or integration module to an already existing CA provided by the present invention operates seamlessly with e-mail applications, business applications, web browsers, wireless and PDA devices, music players and similar electronic devices that might store and/or forward digital content, including electronic books, wallets and the like. Significantly, all of the applications just described function virtually identically to how they function with the implementation of the PKI of the present invention. Accordingly, users of such applications and devices need not learn the complexities of PKI, but rather can simply benefit from a PKI's protection.

The present invention comprises two main components: (1) a local agent, in conjunction with an application specific interface (ASI) (sometimes referred to herein collectively as the local agent), and (2) a control server, which, when required, is in communication with the local agent using http (or FTP) via the Internet. It should be understood by those skilled in the art, however, that these two components can function independently or in combination to achieve the objections of the present invention. That is, the present invention is directed to these components independently and in combination. The local agent/ASI combination preferably is a transparent, operation system (OS) independent application that operates in conjunction with a pre-selected application such as an email client, media player, or business application process. For example, the local agent makes it possible for a user to operate existing messaging software applications in substantially their conventionally way, yet provides the necessary integration to employ PKI-based encryption using that messaging software application. The primary functions of the control server, on the other hand, are to receive messages and encrypted content from the local agent, access appropriate PKI support components, pass messages and content back to the local agent initiate audit trails, and transmit to an intended is recipient. To accomplish these tasks, the control server preferably has access to, among other functional units, both application services functionality and PKI certificate and management processes.

PKI-based encryption is an inherently closed system. That is, when a sender encrypts with a recipient's public key and signs with his own private key, it is assumed that the sender has the recipient's public key and that the sender and intended recipient are affiliated with the same certificate authority. This closed system/process has always been at the cornerstone of PKI encryption. Indeed, PKI-based encryption functionality cannot be attained without having both parties communicating within this closed system. Unfortunately, it is not always the case that everyone subscribes to or is affiliated with the same certificate authority. Historically, this has been one of the most difficult hurdles to overcome to achieve widespread use of PKI-based encryption.

The present inventors studies this problem and have identified a solution to make PKI-based encrypted available in a simple and seamless way. More specifically, the present inventors have identified that can be described, primarily, as “back office” functions such as certificate management, issuance, recycling, and key management. Likewise, the present inventors have identified those functions that can be described, primarily, as “front office” or execution and integration functions. In accordance with the present invention, the so-called back office functions are loaded or controlled from the control server, while the integration functions are aggregated and embodied in the local agent/ASI. In other words, in accordance with the present invention, the functionality of a classic, well-conceived and “bulletproof” security process (i.e., PKI-based encryption) is reorganized and separated into back office functions (the control server and/or units in communication therewith) and execution and integration functions (the local agent). These physically separated functions operate in conjunction to achieve full PKI-based encryption, digital signature authentication, and digital rights management in a seamless and efficient manner.

Overall, the present invention is a robust combination of software routines, private/public keys and digital certificate management services, encryption and technological design to create a unique, effective, and easy-to-use tiered system and method of transmitting and receiving sensitive information (data) via the Internet. Once the information encrypted, that is, formed into a wrapped package in accordance with the present invention, the wrapped package (or encrypted content) is sent either to the control server, or directly to another local agent in a “peer to peer” fashion. The control server controls all security, authentication, tracking, confirmation, and archival of all such encrypted content, thereby providing an increase layer of security and monitoring.

In accordance with a significant feature of the present invention, the encrypted content maintains its encrypted form through its “life”. Thus, when encrypted content is received by a recipient's local agent, the local agent decrypts all or part of the package (encrypted content) based on proper key access, and preferably lists the content as though it were a conventionally received email (e.g., into MICROSOFT OUTLOOK or LOTUS NOTES), downloaded music file (e.g., an MP3 file), business transaction (e.g., an XML file), or any combination thereof. The local agent also processes the “wrapper” associated with the encrypted content (package) to control forwarding or other dissemination possibilities. After use, the decrypted content is preferably destroyed preventing other, non-authorized persons or processes, from seeing, using or playing the data. Thus, even after content is received by the recipient, the further dissemination of the content can be controlled in accordance with the sender's wishes.

In accordance with an implementation of the present invention, a recipient of encrypted content can be notified in one or more of several different ways including e-mail, fax, phone, cell phone, pager, or other wireless device.

In accordance with the present invention, the recipient of the encrypted content will be prompted for RSA passcode. The authenticator generates a one-time passcode every 60 seconds and verifies both the passcode and the recipient's password or personal identity number (PIN) before granting access.

In another important aspect of the present invention, the sender of the encrypted content controls the proliferation of the content. Via menu-driven restrictions, the sender can dictate whether the content can be printed, whether it can be forwarded, how many times it can be viewed or listened to, and whether it should self-destruct, i.e., permit viewing (listening) one time only, after one or after a predetermined number of uses.

It is conceivable that some intended recipients of content that is encrypted in accordance with the present invention will not have, and do not intend to load a local agent/ASI in their electronic device. In such cases, the present invention still provides a means by which the intended recipient can receive encrypted content that still carries the sender's desired dissemination rules. More specifically, when it is detected that an intended recipient is not a registered user of the system of the present invention, or does not have a local agent/ASI installed, the intended recipient preferably receives a notification email, for example, that includes a link (URL) to a web server. When that link is established an applet is preferably downloaded and executed to the intended recipient's web browser or HTML enabled email client. The applet, preferably written in an operating system independent language such as JAVA, and preferably executing within the browser “sandbox” to avoid any installation issues, includes the decryption functions that a local agent would normally include. Moreover, the applet, like the local agent of the present invention, fully controls the window in which the content is viewed, whereby copying and other editing functions are precluded, even when presented inside the web browser or email client. If the encrypted content was originally generated as an email with an attachment, the attachment is preferably converted to a multi-page TIFF or JEPG file that is itself encrypted, before being sent to the applet. Accordingly, even if an intended recipient does not have a local agent, the principles of the present invention (e.g., life-of-content control) can still be implemented.

In an alternative embodiment, the local/ASI may actually be embedded to the encrypted content.

The foregoing and other objects, features and advantages of the secured content delivery system and method will be apparent from the following more particular description of preferred embodiments of the system and method as illustrated in the accompanying drawings in which like reference characters refer to the same parts through the different views. The drawings are not to scale, emphasis instead being placed upon illustrating the principles of the invention.

### BRIEF DESCRIPTION OF THE DRAWINGS

Certain embodiments of the present invention is described with reference to the following drawings, wherein:

FIG. 1 is a block diagram illustrating one embodiment of the system of the present invention;

FIG. 2 is a flowchart illustrating an exemplary content creation and sending process in accordance with the present invention;

FIG. 2A is an exemplary illustration of the positioning of specially provided button and menu selection with an email application in accordance with the present invention;

FIG. 3 depicts an exemplary dialogue box for selecting level of security and content dissemination rules in accordance with the present invention;

FIG. 4 is a flowchart illustrating an exemplary content reception and viewing process in accordance with the present invention;

FIG. 4A is an exemplary illustration of a local agent-controlled content viewing window in accordance with the present invention;

FIG. 5 illustrates a bill presentment and high-volume component architecture in accordance with the present invention;

FIG. 6 illustrates how the standard or current MP3 file format may be modified in accordance with the present invention;

FIG. 7 depicts a process for generating the modified MP3 file layout or format illustrated in FIG. 6;

FIGS. 8-10 illustrate an exemplary decryption process for encrypted MP3 files in accordance with the present invention; and

FIG. 11 is a block diagram illustrating an exemplary embodiment of the wireless trust system of the present invention.

### DETAILED DESCRIPTION OF PREFERRED EMBODIMENTS

The present invention is directed to a secured content delivery system and method in an electronic network.

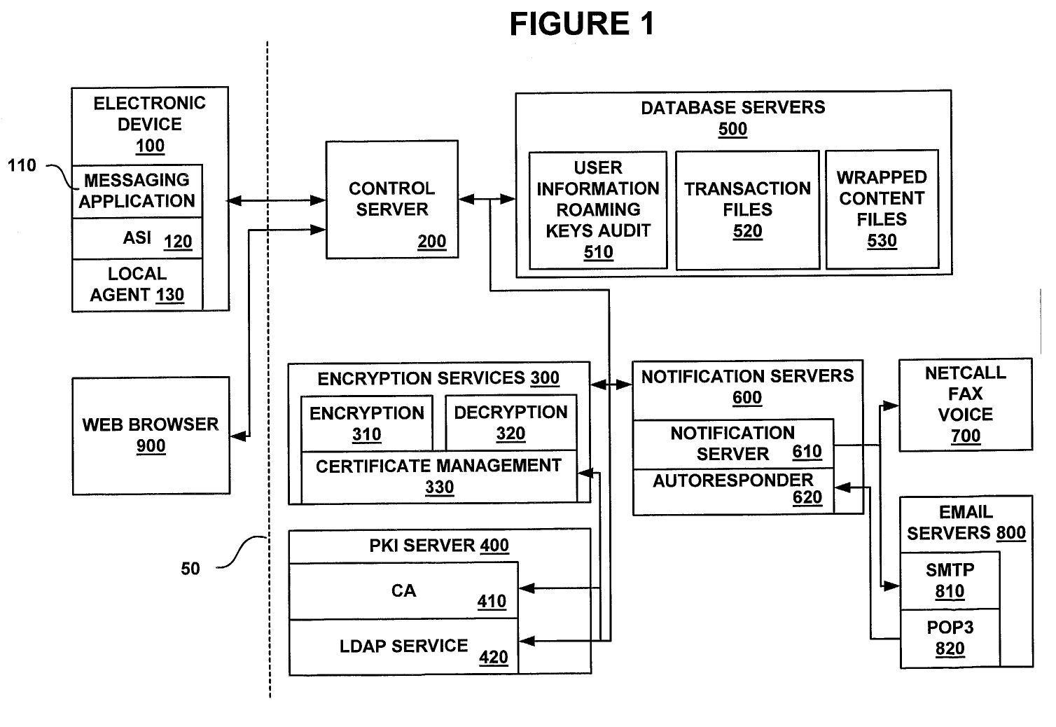

FIG. 1 is a block diagram illustrating one embodiment of the system of the present invention. One important achievement of the present invention is providing simple and accessible public key infrastructure (PKI) based encryption to users who or processes that might not otherwise implement a robust encryption scheme such as PKI due to the difficulty of its user or its integration issues. The present invention overcomes these issues by splitting the PKI process between front end (i.e., local) functionality and back end functionality. In accordance with the present invention these functionalities are combined seamlessly, from the user's or process's perspective, by employing the capabilities of the Internet to automatically pass messages, keys, authorization and content between the front and back end processes.

The following description of the present invention is directed, primarily, to implementing PKI-based encryption in an email application such as LOTUS NOTES or MICROSOFT OUTLOOK. A latter part of this specification outlines how any form of content, e.g., a bill, statement, business transaction, an audio file or other streaming media, can be encrypted and controlled by implementing the principles of the present invention.

Referring a FIG. 1, an electronic device 100 such as, but is not limited to, a personal computer or personal digital assistant (PDA) includes a messaging application 110 such as LOTUS NOTES, MICROSOFT OUTLOOK or any number of other email clients. Also loaded on electronic device 100 is a local agent 130 that is able to automatically communicate with messaging application 110 via application specific interface (ASI) 120. ASI 120 preferably is a collection of software code that is written using tools made available by messaging application 110 in order to externally control messaging application 110. This software code preferably relies on “hooks” and like software functions which the messaging application itself makes available to software developers. For instance, many messaging applications come with a so-called “software developer's kit” that permits a software developer to configure and customize the messaging application's functionality including, for example, it graphical user interface.

Local agent 130 preferably comprises code (e.g., scripts and dynamic link libraries (DLLs), or JAVA archive files or libraries (JAR files)) that, via ASI 120, configures messaging application 110 and enables a user to seamlessly access the so-called “back office” functionalities of the present invention. More specifically, local agent 130 preferably enables electronic device 100 to connect to control server 200, to request a certificate and to encrypt and decrypt wrapped content, which will all be explained in more detail later herein.

The following modules preferably make up local agent 130 for the LOTUS NOTES email application:

| | |
|---|---|
| (a) LocalAgent.dll | This module includes core local agent |
| | functionality including accessing message |
| | body text, attachment, and other message |
| | related information from the Lotus |
| | interface. |
| (b) Config1.exe | This is a “wrapper” for LocalAgent.dll and |
| | pulls configuration dialog and facilitates |
| | configuring of proxy settings to enable |
| | local agent 130 and electronic device 100 |
| | to use their connection to the Internet [symbol] . |
| (c) Conwiz.scp | This module includes the IP addresses of |
| | control server 200 [symbol] . |
| (d) InstallScrpits.exe | This module installs Lotus Scripts into the |
| | user's mail database that allow Lotus Notes |
| | to access the LotusPluginDll.dll [symbol] . |
| (e) Leppn201.dll | This is a Lotus Notes CPP API runtime |
| | file. It is required so that LotusPlugDll.dll |
| | can access the user mail database [symbol] . |
| (g) LotusPluginDll.dll | This is the LOTUS ASI 120 and provides |
| | communication between the LOTUS Notes |
| | database and local agent 130 [symbol] . |
| (h) Nnotes.dll | This is the Lotus Notes CPP API runtime |
| | file. It is required so that |
| | LotusPluginDll.dll can access other Lotus |
| | mail functions. |
| (i) PackageEncrypt | This module encrypts packages (i.e., |
| | content) using RSA algorithms; |
| (j) SessionEncrypt | This module perform RSA client/server |
| | session encryption, i.e., between local |
| | agent 130 and control server 200 [symbol] . |
| (k) Transport.dll | This module provides HTTP transport layer |
| | communications from local agent 130 to |
| | control server 200 (also incorporated into |
| | LocalAgent.dll). |

Although the foregoing modules are identified separately, those skilled in the art will appreciate that the different functions described can be combined or grouped together in any number of ways depending on software developer preferences and code efficiencies.

As shown in FIG. 1, local agent 130 is in communication with control server 200 in order to access the so-called “back office” functions that are implemented, generally, with elements 300, 400, 500, 600, 700 and 800, the details of which are described below. Control server 200 in combination with components connected to it enable local agent 130 to access the PKI-based encryption services provided by the present invention. The collection of back office components (to the right of dotted line 50 in FIG. 1) manages connections, and directs service requests to the appropriate component for service execution. For example, control server 200 preferably is in communication with an LDAP directory service 410 via PKI server 400 to retrieve a user's signing and encryption keys to provide to a local agent 130, and is further in communication with database servers 500 to access appropriate user login and package information.

In this regard, control server 200 preferably includes the following modules:

| | |
|---|---|
| (a) com.control.logging | An event logging module that handles all the |
| | logging of events and exceptions into a |
| | database 520. |
| (b) com.control.node | This is a process controller module that |
| | controls all the subnode processes that are |
| | being executing (e.g., notification, application |
| | services, auto responder). |
| (c) com.control.security | This module provides sessions security. That is, |
| | it manages connection security in that it |
| | handles connection to a |
| | SessionJavaWrapper.dll. This module is a |
| | wrapper class that marshals the data between |
| | the Java Native Interface and the |
| | SessionEncrypt.dll which uses Diffey-Helman |
| | Key agreement to secure access. Connection |
| | security implemented between control server |
| | 200 and local agent 130. |
| (d) com.control.server | This module functions as a connection manager |
| | which listens for connections on a |
| | predetermined port (e.g., port 80) and handles |
| | each connection and request as it comes in. In |
| | other words, this module handles the initiating, |
| | executing and terminating of connections |
| | between control server 200 and local agent 130. |
| (e) | This module is a service director that handles |
| com.control.server.edoc | the uploading and downloading of files and |
| server | encrypted content, manages interactions with |
| | LDAP service 420 to retrieve signing and |
| | encryption keys for local agent 130, manages |
| | database connections (e.g., to database |
| | servers 500), stores encrypted content in |
| | appropriate databases, manages password and |
| | key agreement exchanges, and generally |
| | handles HTTP exchanges for control server |
| | 200. |
| (f) | This module manages the interactions and data |
| com.control.server.edoc | representations for each session that is initiated |
| server.session | with control server 200. |

Each of the individual components identified as “back office” functions will now be explained in further detail. Encryption services 300 comprise encryption routines 310, decryption routines 320 and certificate management routines 330. Encryption routines 310 provide services for the encrypting of data sent to local agent 130 from control server 200 using, preferably, a 128 bit session key. Decryption services 320 provide the facilities to decrypt the communication data received from local agent 130 using a 128 bit session key.

PKI server 400 is accessed when a certificate (e.g., a certificate in accordance with the X.509 standard) is necessary to implement encrypted communication. PKI to server 400 preferably can generate its own certificates via Certificate Authority (CA) 410 or can employ LDAP service 420 to acquire certificates or keys from other certificate authorities, as desired. All such functionality, in accordance with the present invention is accomplished absent any express direction from a user of electronic device 100, except to the extent that the user or process has indicated a desire to employ PKI-based encryption that is made available through the implementation of the present invention, or to the extent that the content that the user desires to view (use) is accessible only by first obtaining necessary keys and/or certificates.

Similarly, local agent 130, when necessary, automatically notifies CA 410 of public key(s) required. Local agent 130 then retrieves the appropriate key(s) across an encrypted connection (e.g., SSL), and then executes a signing an algorithm with a private key on the content. On the recipient side, the same process occurs except that a signature authentication algorithm is executed using the appropriate public key.

Database services 500 comprise several databases that are accessed on an as-needed basis by control server 200 or other components of the present invention to maintain the automatic and seamless implementation of PKI-based encryption. Specifically, there is preferably included a user information, roaming keys and audit database 510, a transaction files database 520 and a wrapped content database 530. User information, roaming keys and audit database 510 stores information related to individual users and keys that can be used by those users in the event the user is not operating from an electronic device 100 that has a local agent 130 installed. Transaction database 520 preferably records each instance of wrapped content that is handled by control server 200 so that a full listing of the operation of the system may be generated as desired. Finally, wrapped content database 530 stores interim copies of wrapped content that is en route to a final recipient. Transaction database 520 and audit database 510 may be accessed and updated from initial package creation to post-reception. Wrapped content database 530 is accessed and updated upon package creation and download.

Notification component 600 preferably comprises a notification server 610 and an autoresponder server 620. Notification server 610 is preferably in communication with a netcall server 700 that can notify an intended recipient that wrapped content is awaiting their pick up. Such notification preferably includes notification via the Internet, facsimile, and/or voice circuits, which ever might have been previously selected by a user. In addition, and preferable in the case of an email implementation, the recipient is notified that wrapped content is awaiting via email server 800, and in particular SMTP 810. In the event of the erroneously address email, the email server's POP3 820 triggers autoresponder server 620, which alerts control server 200 that an email has not been properly delivered and to take corrective action, namely, pass a notification back to the appropriate local agent 130.

The operation of the present invention will now be described in the context of an email application, namely, LOTUS NOTES. If should be noted that the process is similar for all forms of digital content described herein. As already noted, the present invention provides a means for users of an email application such as LOTUS NOTES to send and receive secure electronic message, “wrapped content” or “packages” with advance control over the message's ultimate disposition. Recipients preferably receive their message securely through various means including another email application supporting the functionality of the present invention. In accordance with the present invention, content is strongly encrypted before leaving its origin. The encrypted or wrapped content is transmitted in that form and stored in that same encrypted format on the recipient's electronic device (e.g., his computer). Disposition or dissemination rules are also preferably wrapped within the content. These rules wrapped with the content are set by the content sender and, preferably, can only be deciphered by local agent 130 and, when necessary, control server 200. For example, sender may elect to have content viewed only once and/or set authentication options for a recipient whereby the local agent on the recipient's computer will permit viewing of the content one time only and/or will require predetermined sign-in requirements which results in robust authentication.

Generally, the intended recipient is notified when content is awaiting pickup. While a recipient need not be a subscriber of the back end functionality provided by the present invention, recipient of the content may be authorized only if the recipient first registered with the back end functionality, namely, the appropriate user database. In a preferred embodiment, when the recipient downloads the content as well as when he views or uses the content, the sender is preferably notified.

A more detailed description of the foregoing process follows. If a user does not presently have the appropriate local agent 130 and application specific interface (ASI) 120 already loaded on his computer, then, that user must first connect with control server 200, optionally identify themselves through a registration process, and obtain the “front end” or integration components preferably including a personal digital certificate, i.e., local agent 130 and ASI 120 (or a combination thereof). In particular, this installation wizard of the present invention, available via control server 200 over the Internet, installs the necessary script code that calls the local agent from within the standard LOTUS NOTES menu. Then, the connection wizard automatically runs and determines a method whereby the electronic device 100 on which local agent 130 is being loaded can connect with control server 200. At this point, local agent 130 prompts the user for a certificate passphrase. Control server 200 then verifies logon and the certificate passphrase using, preferably, an SSL connection. Local agent 130 then encrypts the logon password and stores the passphrase in a registry that is not accessible to the user. In addition, the certificate passphrase is preferably hashed and stored in the user's certificate profile in database 510. At this point, the electronic device 100, i.e., computer, holds a complete user profile, including validated, hashed certificate passphrase and private keys encrypted with the user's certificate passphrase. A secured environment now exists for offline access to encrypted content. Logon password and certificate passphrase can be validated against the registry and the user profile. The passphrase is required to access the private key to permit decryption of the encrypted content.

Once the one-time set procedure is complete, the user is ready for subsequent online or offline sessions to send and receive encrypted content.

Thus, for transmitting a new encrypted message, a LOTUS NOTES user preferably composes an email message as is conventional. Files may be attached to the email message as well. Then, instead of clicking on the traditional “send” button provided by LOTUS NOTES, the use preferably clicks a specialized button, provided by the present invention via the InstallScripts.exe module, thereby launching the PKI-base encryption services. At this point local agent 130 saves the email message to the LOTUS NOTES database and launches a login procedure to control server 200. The user is then prompted for and then enters authentication information (e.g., a passphrase or biometric identification) and the memo (email message) is encrypted using PKI cryptography. That is, the email and/or any attachments is encrypted using CAST-128 and optionally signed using a certificate based SHA-1 signed MD5 hash value to create a “package”. This package is then transmitted to control server 200 via HTTP or FTP, preferably using an SSL connection. Waybill information affirming the complete, uncorrupted transmission of the package is subsequently transmitted to the LOTUS NOTES application. A globally unique tracking number is then assigned to the package and it is stored, for example, in database 530. Finally, the “sent” database in LOTUS NOTES is updated to indicate that an email has been sent.

The recipient of the package, assuming he is already a registered user of the present invention, is notified of an awaiting package by the means he has previously selected, e.g., facsimile, telephone, pager and/or email-based notification. If the intended recipient is not a registered user of the present invention then the recipient is sent an email message containing either (1) sign-up information form a new account or (2) a URL that will take that recipient directly to view the encrypted content, upon verifying recipient credentials, using an SSL connection.

For a typical recipient who also happens to be a LOTUS NOTES application user, for example, the following reception process occurs. After being notified of an awaiting package, the recipient selects a special receive button (provided via ASI 120) within the LOTUS NOTES graphical interface. After being prompted for and entering authentication information, local agent 130 automatically connects to control server 200 via HTTP or FTP. The awaiting package, or encrypted content, is then sent from database servers 500 to local agent 130 and, ultimately, the content is stored, encrypted, on device 100. In a preferred embodiment of the present invention, an email is also sent to the original sender notify the sender that the package has been received by the intended recipient. Once the package is stored on device 100, a status information memo (entry) is created in the appropriate LOTUS NOTES database (e.g., “inbox”). The status information memo (entry) includes a brief message identifying the subject, sender and tracking number of the package. Thus, to view the contents of the package, the recipient simply double clicks on the entry in the LOTUS NOTES “inbox” database. This causes local agent 130 to launch a viewer (preferably a separate window controlled by local agent 130) within which the encrypted content including any attached files are decrypted and, thus, view. The local agent automatically prompts the recipient for any required passphrase and automatically retrieves any keys necessary to view the encrypted content that is the subject of the email. Such key retrieval might include automatic communication with control server 200 to obtain keys via CA 410 or LDAP service 420. In accordance with the present invention, even after the local agent-controlled view (window) is exited, the content that was just viewed remains encrypted on the recipient's machine.

An operating environment for electronic devices and servers of the present invention includes a processing system with at least one high speed Central Processing Unit (CPU) and a memory. In accordance with the practices of persons skilled in the art of computing programming, the present invention is described below with reference to acts and symbolic representations of operations or instructions that are performed by the processing system, unless indicated otherwise. Such acts and operations or instructions are referred to as being “computer-executed,” “CPU executed,” or “processor-executed.”

It will be appreciated that acts of symbolically represented operations or instructions include the manipulation of electrical signals or biological signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (RAM)) or non-volatile (e.g., Read-Only Memory (ROM)) mass storage system readable by the CPU. The computer readable medium includes cooperating or interconnected computer readable medium, which exist exclusively on the processing system or be distributed among multiple interconnected processing systems that may be local or remote to the processing system.

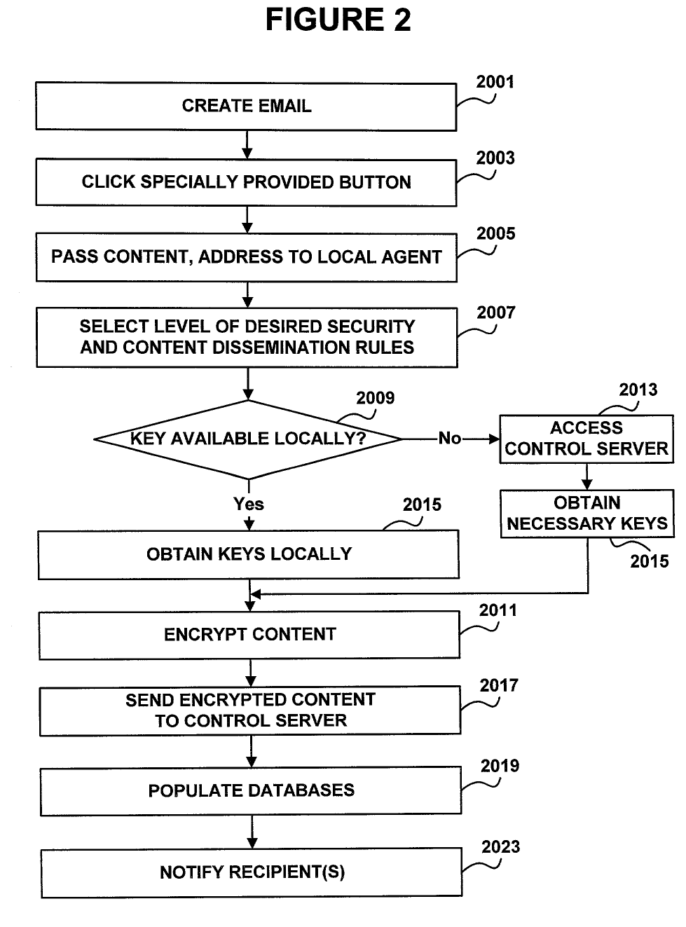

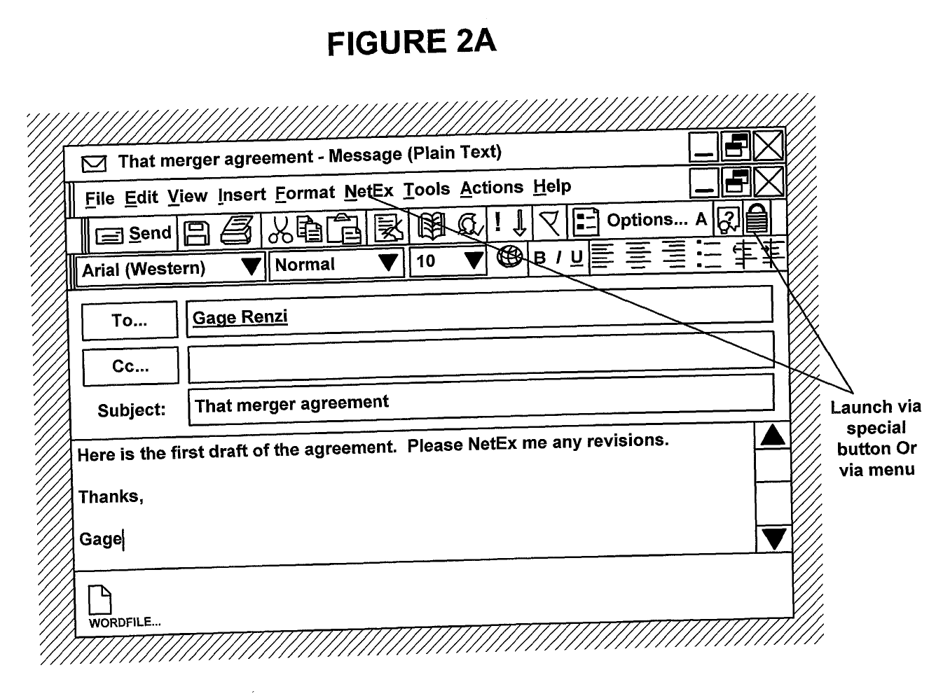

FIG. 2 is a flowchart depicting an exemplary process in which an email is created and forwarded via control server 200 to a recipient. At step 2001, an email is created within a messaging application such as LOTUS NOTES. Then at step 2003, instead of clicking on the conventional “send” button, a special button is provided within the graphic user interface, and this button is clicked to launch the encryption mechanisms provided by the present invention. FIG. 2A is an exemplary illustration of the positioning of the specially provided button or a menu category within an email application in accordance with the present invention.

Returning to FIG. 2 at step 2005, application specific interface (ASI) 120 passes the content of the email and address information to local agent 130. At step 2007, local agent 130 prompt the user to select a level of desired security for the encrypted content and content dissemination rules. (This aspect of the present invention will be discussed in further detail below). Local agent 130 then determines at step 2009, if the appropriate encryption keys are available in local registries (within the local agent). If local registries do contain the necessary keys, then at step 2011, those keys are fetched. If the appropriate keys are not available locally, local agent 130 accesses control server 200 via, preferably, an SSL connection at step 2013. Then at step 2015, local agent 130 requests and obtains the necessary keys from control server 200 (which itself accesses PKI server 400 or encryption services 300, as required). Once the keys are obtained via either step 2011 or step 2015, the email content is encrypted with the appropriate keys at step 2017. Also at this step, the desired level of security and content dissemination rules are preferably wrapped with the encrypted content (details of this feature of the present invention are discussed below). The encrypted content (or, alternatively, the wrapped content or package) is then sent, at step 2019, to control server 200, preferably, via an SSL connection whereupon, at step 2021, the appropriate databases 510, 520, 530 are preferably populated as described above by database servers 500. Finally, at step 2023, the intended recipient of the encrypted email is notified via notification servers 600 in conjunction with component 700 and/or email server 800. Thus, except for clicking in a specially provided button, the sender exploits the robust security and authentication features of PKI-based encryption in a fully automated manner.

Not only does the present invention provide PKI-based encryption in a seamless and user friendly manner, but the present invention further provides a life-of-content feature which permits a sender or creator of content to control the dissemination of that content even after it has been delivered to intended recipients.

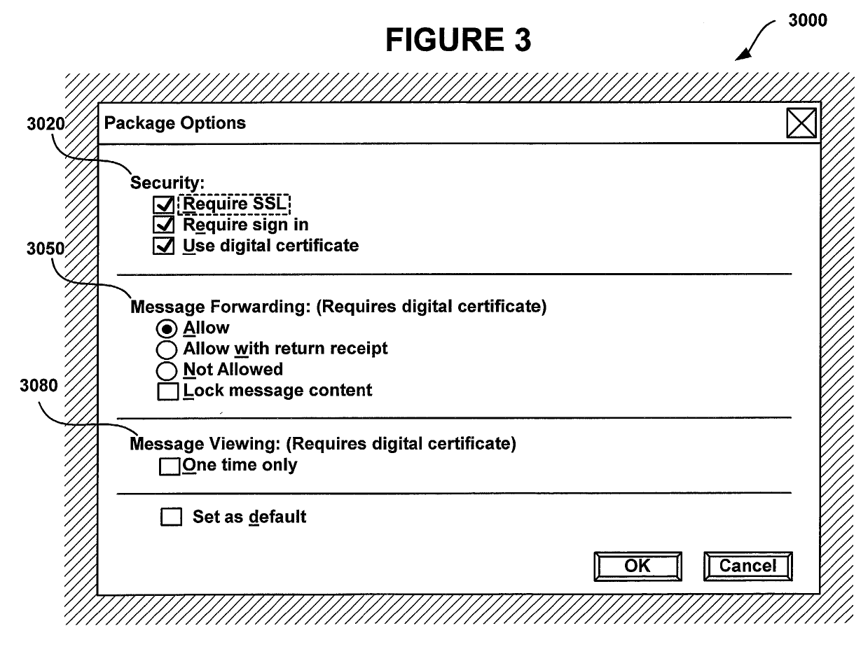

Referring to FIG. 3, the menu 3000 illustrated is preferably presently to a content creator at, e.g., step 2007 of FIG. 2. Specifically, a number of options can be assigned to each package or encrypted content that is individually acted upon by the creator and present invention. As shown, there are three distinct levels of security 3020 that can be chosen. First, SSL can be required in order for a recipient to be permitted to view the package. Second, a sender or creator can require that the recipient sign into control server 200 of the present invention using a password. Finally, the sender can also require that the recipient use a digital certificate (including necessary passphrase) in order to view the package materials. Such a certificate ensures proper authentication. In this final case, the certificate management routines 330 of the present invention may be employed to provide the appropriate certificate.

Content dissemination is also controlled by the creator or sender in accordance with the present invention, resulting in robust digital rights management (DRM) capabilities. The control of content dissemination is effected using the options labeled Message Forwarding 3050 and Message Viewing 3080 in FIG. 3. There are four options that can be selected in Message Forwarding 3050: allow, allow with return receipt, not allowed, look message content. In addition, though not shown in this example, the sender can preferably also choose to digital “shred” or destroy the content based on a particular date or number of times viewed, and allowed or disallow print and/or copying/saving. With the “allow” option selected, a recipient is permitted to forward the content at will without any restrictions. In this case, no special rules are wrapped with the content. If the “allow with return receipt” option is selected, then when the content is forwarded, the original sender will receive notification of such an event. In this case, an appropriate rule (or code) is originally wrapped with the content such that when the recipient attempts to forward the content, local agent 130 automatically contact control server 200, which in turn communicates with database server 500 and notification server 600 to effect the proper notification that the content has been forwarded. In this way, the original creator or sender can keep track of the content and, where appropriate, derive revenue from the dissemination thereof. Recall that the content remains encrypted even after it is sent to the recipient and, preferably, only local agent 130 can detect and decipher the rules that have been wrapped with the content. In view of the above, note that notification of a forwarding event can occur for the first forwarding event only and/or for all subsequent forwarding events.

Under the “not allowed” option, the recipient is forever block from forwarding the content. Finally, using the “lock message content” the recipient is block from editing the text in the message upon saving or forwarding.

Under the Message Viewing 3080, the creator or sender can confine the viewing of the content to one time only. That is, the wrapper associated with the content preferably includes a rule (or code) that causes local agent 130 to deny any request to view the content after the content has been viewed once. Of course, the wrapped associated with the content, can also be designed so that local agent 130 is caused to automatically contact control server 200 each time the recipient attempts to view the content. In this way, it is possible to control how many times a recipient can view (or use) the content. Appropriate database (not shown) can be arranged to keep track of how many times a user has viewed or accessed content, thereby enabling a content creator or sender the ability to track and monitor content use on a use-by-use-basis. Alternatively, local agent 130 itself can comprise a counter that is incremented or decremented each time content is used. Likewise, a limit to how many times the content, or date/time frame the content can be viewed (or used) can be encoded with the wrapped content such that local agent 130 can control access to the content without having to access control server 200.

Those skilled in the art will appreciate that any of the foregoing dissemination control features can be set as default settings, thereby avoiding the selecting process at each sender transaction.

Receiving an email message (or other content) in accordance with the present invention is similar to sending the content in the first place, albeit the order of events is somewhat reversed.

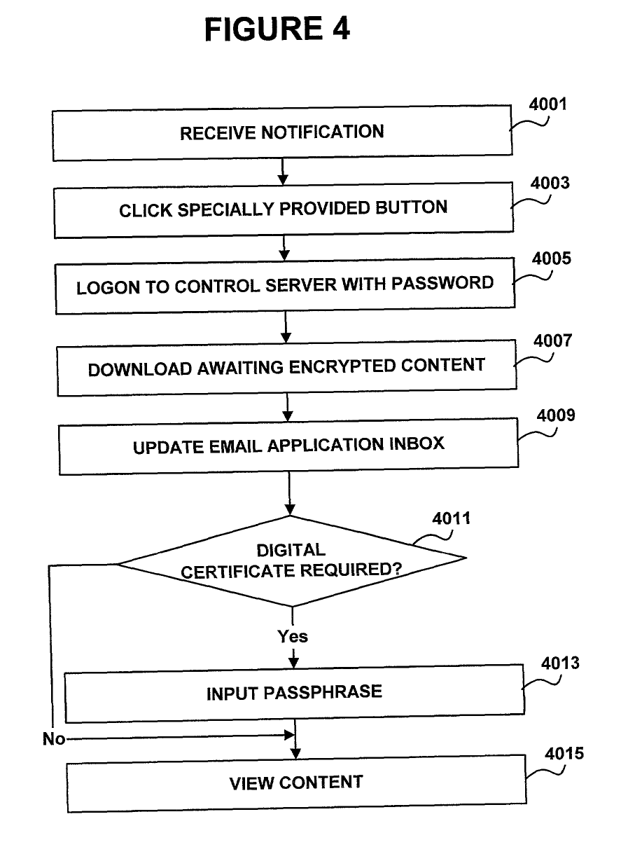

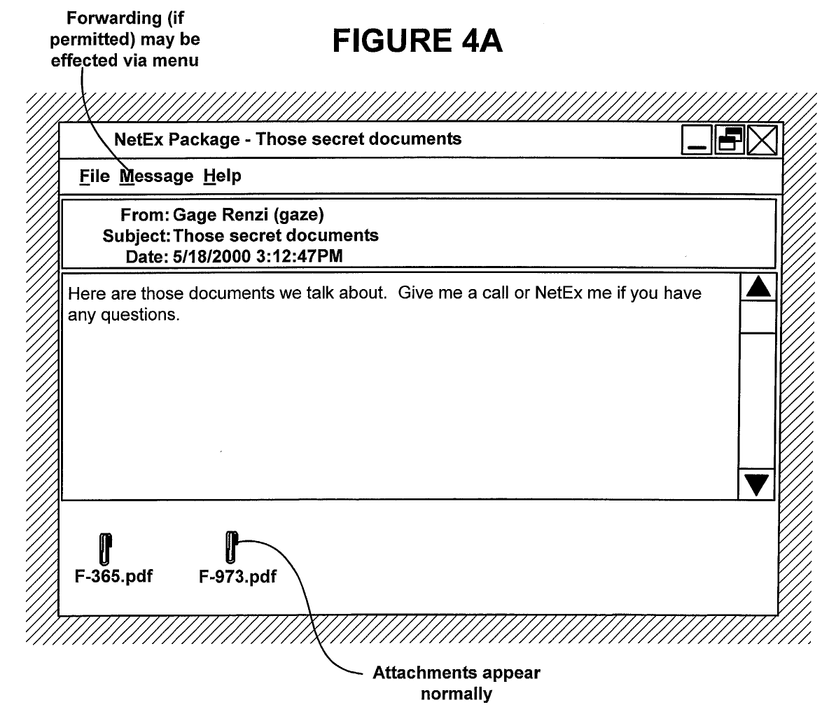

FIG. 4 depicts a flowchart that illustrates an exemplary process for receiving an encrypted email message in accordance with the present invention. After notification is received at step 4001, that content (or a package) is awaiting retrieval, a user clicks on a special button, or menu option, provided with the graphic user interface of the content delivery system (i.e., LOTUS NOTES in the present example), step 4003. This action causes local agent 130 to prompt the user for a password after which local agent accesses control server 200 at step 4005. At step 4007, control server 200 communicates with database servers 500 to fetch the awaiting package(s) and downloads that package(s) to the intended recipient. At step 4009, local agent 130 causes the inbox of LOTUS NOTES to be updated with a new entry indicative of a received message. By clicking on this new entry, the user will either be permitted to immediately view the message, assuming no digital certificate is required by the dissemination rules wrapped with the content (step 4011 and 4015) or the user will have to supply a passphrase, biometric, or other authentication device, step 4013, that authenticates that user as the true intended recipient. The viewer, or separate window, controlled by local agent 130 is then launched and the content is viewed (or used) by the user at step 4015.

FIG. 4A is an exemplary illustration of a local agent-controlled content viewing window in accordance with the present invention in which a menu can be accessed to effect content dissemination (forward, copy, etc.), assuming such dissemination is permitted. Also, as shown, attachments are easily accessed with the local-agent controlled window.

Encrypted Browser Content

The present invention can be used not only to encrypt data that is passed through an electronic messaging application such as LOTUS NOTES or MICROSOFT OUTLOOK, but also to pass browser content across the Internet. FIG. 1 also shows a web browser 900 that is preferably also associated, by conventional means, with electronic device 100. The browser 900 is shown separately to emphasize that each application (e.g., messaging application, browser application, etc.), on its own, can exploit the principles of the present invention. As with the messaging application, an application specific interface (ASI) 120 is provided to interact with the browser 900 and pass information to and from a local agent 130 that is installed on the electronic device 100. Encrypted content is passed to and from the browser 900 using key pairs and certificates in the same way as described above. The ASI 120, on the other hand, is tailored to each application for which the PKI encryption techniques of the present invention is desired.

Applet Functioning As Local Agent

It is conceivable that some intended recipients of content that is encrypted in accordance with the present invention will not have, and may never load, a local agent 130/ASI 120 in their electronic device 100. For example, corporations are often hesitant to allow their employees to import executable files inside the corporation's network firewall. In such cases, the present invention still provides a means by which the intended recipient can receive encrypted content that still carries the sender's desired dissemination rules.

More specifically, it an be determined from the user information database 510, or from the sender's local agent 130, that an intended recipient is not a registered user, i.e., the intended recipient does not have a local agent installed or loaded. So, instead of sending a notification to the intended recipient that a “package” is awaiting pickup as described in the previous embodiments, control server 200 sends the recipient a hyperlink (URL) notification that when clicked, launches a web browser or the HTML features of an HTML-enabled email client. The server located at the said URL then downloads an applet, preferably coded in an operating system independent language such as JAVA. More often than not, corporations do not restrict such applets as long as the applets operate in within what is referred to, by those skilled in the art, as a “sandbox” of the browser (or HTML-enabled email client). The dynamically downloaded applet therefore loads and runs within the temporary cache of the browser and then reaches out (via, e.g., the Internet) to control server 200 and pulls down the appropriate file to be viewed. This file, of course, is still encrypted as it arrives with the applet. The applet thereafter decrypts the encrypted content and then act as (or controls) a viewer for that content, whether it be a text, data or a graphic file.

Thus, it is possible to control the content that has been sent in the sense that the sender can still associate dissemination rules with the encrypted content and the dynamically downloaded applet controls how that content can be used, namely whether it can be selected (copied), printed, forwarded, or viewed more than once or within a selected time frame.

More specifically, a recipient is precluded from selecting (copying) or printing (outside what is allowed by the dissemination controls) what is seen within the viewer (assuming the sender so desires) since the actual image or the text that is being viewed is never stored outside of the browser sandbox; and thus no other portion of an operating system (OS), such as MICROSOFT WINDOWS can gain external access to it. The browser receives the applet only and the applet itself fetches the content and views it. Of course, there may be a size limitation to the content that can be viewed at a given time which is determined, essentially, by the amount of RAM that has been dynamically assigned to the browser's “sandbox”. If the content is in fact too large for the “sandbox”, a message is preferably displayed for the recipient indicating that, in order to view the content, the recipient should allow dynamic download and install of the applet to run outside the “sandbox”. This message may instead ask the user to download a “true” local agent associated with ASI.

When the recipient has finished viewing the content, the browser is exited, thereby stopping the applet and, as a result, effectively removing the content from RAM as that area of RAM is re-allocated for some other use.

The process just described can also be modified to view email attachments that may, need to be viewed by an application other than an email client. Such an attachment might be a spreadsheet file or word processing document. However, the “life-of-content” control over the attachment would likely be defeated if the applet permitted the launching of the application that would be best to view the substance of the attachment. So, when it is determined that an email with an attachment is going to be sent to an unregistered user (i.e., one that does not have a local agent/ASI), the sender's local agent 130 preferably takes a print image of the attachment and saves it as a multi-page TIFF, or other well-known similar type of image file (e.g., JPEG). As with the previously described embodiments, all of the forgoing is accomplished automatically, with the user's (sender's) intervention. It is this multi-page TIFF that is sent, encrypted with dissemination rules, to control server 200 and ultimately sent to the intended recipient via the dynamically downloaded applet. Accordingly, even without having a local agent/ASI, a sender can still control the dissemination of content that is being sent to recipients.

In an alternative embodiment, a sender sends a message/attachment as previously described. In this case, however, the recipient receives the email/attachment, where the encrypted content is inserted, and encoded, without an HTML attachment (of course, the particular format of the additional attachment is not critical to the invention). The email instructs the recipient to open the HTML attachment. When the attachment is opened a sign JAVA applet is downloaded from the control server 200, for example. In a corporate setting, a proxy server preferably caches the applet automatically until the applet is modified.

The applet thereafter decodes the encrypted content, and DRM/control rights and any “trial” private key embedded in the HTML file. The applet further decrypts the content based on the available key(s) or other DRM data in the document and opens a window within the browser (optionally based on a log file, so below for discussion of the use of log files).

In this alternative embodiment, memory buffer issues no longer apply as the encrypted content is already downloaded in an encrypted state via email. The digital rights management and log paradigm (described below) is thus preferably employed to enforce control options, with the exception the instead of a public/private key pair, a symmetric key pair is preferably used where that symmetric key is either appended into the encrypted content (instead of a private “trial” key) or securely downloaded to the applet based upon subsequent document opening and authorization. The matching symmetric key is preferably stored at another location, preferably at the same server as the applet, e.g., control server 200 or a server in communication therewith. The foregoing embodiment provides additional security and allows “on-the-fly” rule or DRM editing even after a package is sent.

Presentment Services

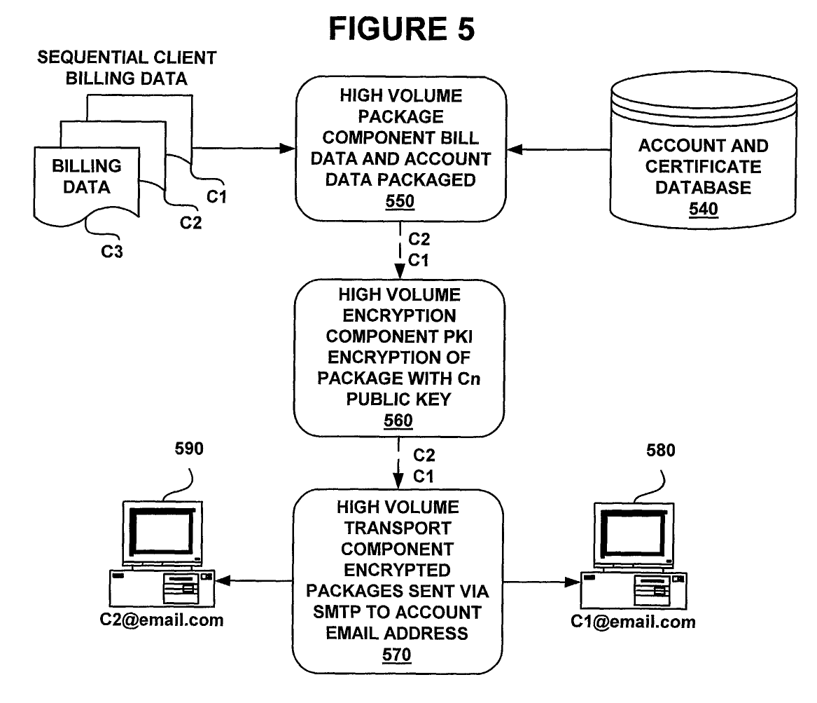

The present invention is also suitable for encrypted “presentment” services. A presentment service might include, for example, electronically delivering statements or bills to a customer or subscriber and wherein the statement or bill is securely encrypted and only the intended recipient can view the contents thereof. Referring to FIG. 5, sequential client billing data C1, C2, C3 is transmitted to high volume package component 550. Component 550 also receives account, public key and certificate data C1, C2, C3 corresponding, respectively, to each client associated with the billing data. The client billing data and account and certificate data are then packaged together and passed to the high volume encryption component 560, which employs PKI-based encrypted using the certificate packaged with the billing data and account data. The encrypted package (i.e., the encrypted bill or statement) is then passed to high volume transport component 570, from which the encrypted packages are sent via conventional SMTP to account email addresses. When each client receives an email, the user's local agent decrypts the statement or bill using the appropriate corresponding private key.

One advantage of the foregoing process is that instead of individual clients “hitting” a server belonging to the billing entity to retrieve their individual bills or account information on, e.g., the last day of a billing period, the billing entity instead “pushes” the bills or statements to each of the clients. Thus, the system and method of the present invention yields significant resource efficiencies. Moreover, this is accomplished using full PKI-based encryption resulting in a robust presentment mechanism and process while avoiding significant numbers of hits on a web server that would normally occur if each of the clients were to try to “pull” his/her own bill or statement from that web server at the same time. This concept of course is not limited to the area of bill presentment, but is applicable to any secure sending of files where authentication of the key is used mainly for transport and audit trail reasons.

Digital Right Management (DRM)

While the present invention has been described thus far with respect to relatively static file types that are encrypted, namely, emails, attachments, data, bills and statements, the present invention is also particularly suited to implementing digital rights management (DRM) and control of data (such as steaming data) including the increasingly popular MP3 music file format. Of course, the discussion below is equally applicable to streaming video or any other standardized file format that may be employed to convey data from one part to another, wherein the sending part intends to keep control of or track of the data even after it has been sent to the second part (i.e., the recipient) or a third party (if forwarding is permitted) and so on.

In accordance with the present invention, customer (recipient) transactions and file transactions are permanently stored locally and encrypted into the relevant file. Offline DRM is also provided via the local agent, thereby opening up “super-distribution” opportunities as access rights are permanently enforced for both the original download site or user of the file, and any “trial” scenario presented as a user forwards the file without accessing a central server. Finally, as with the messaging (email) embodiments described above, from the user's perspective, an encrypted data file (e.g., an MP3 file) preferably retains its basic file structure such that a user's experience data file (e.g., an MP3 file) preferably retains its basic file structure such that a user's experience using the file remains familiar and the equipment used to view, listen to or otherwise use the encrypted data does not need to be modified, except for the addition of a local agent and ASI, which as described previously, can be appended to the content itself.

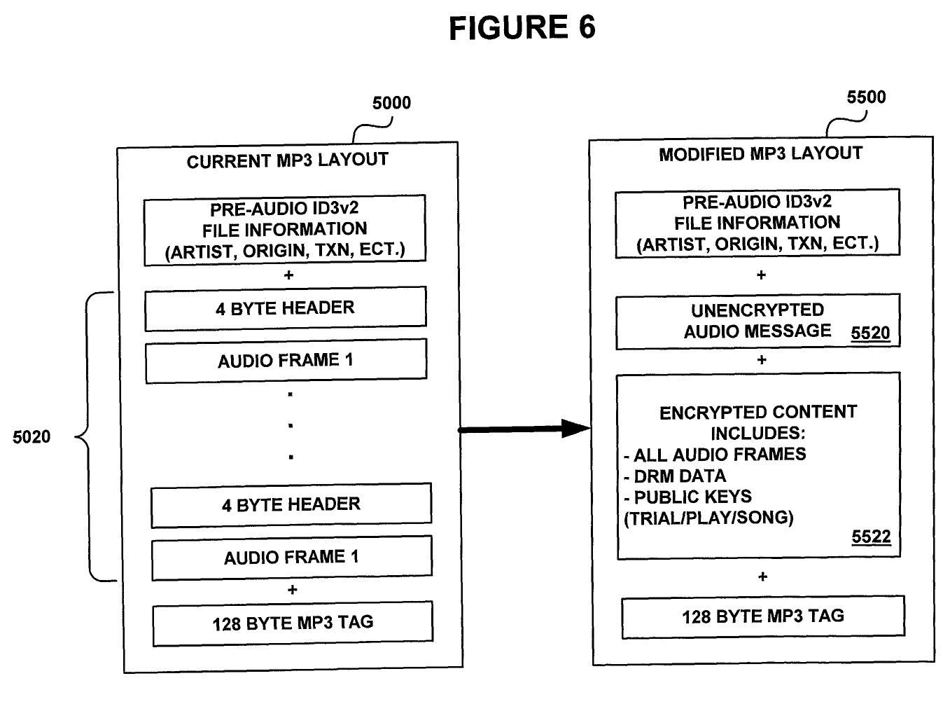

FIG. 6 illustrates how the standard or current 5000 MP3 file format may be modified in accordance with the present invention. As is readily seen, both file formats 5000 and 5500 include the same pre-audio preamble and 128 byte MP3 tag. Accordingly, from the perspective of existing equipment that plays MP3 files, the modified MP3 file 5500 looks the same as a conventional MP3 file format 5000 in that the header and trailer of the modified file 5500 are identical to the header and trailer of a conventional file format 5000. However, instead of including a plurality of conventional 4 byte header and audio frame 5020 combinations, the MP3 file format in accordance with the present invention includes an unencrypted audio message 5520 and encrypted data 5522 including all of the audio frames, DRM data and public keys necessary to decrypt the audio frames and play pre-recorded music.

The unencrypted audio message 5520 preferably includes a message notifying the would-be listener of the MP3 file that the music file is in an encrypted format and only authorized users are permitted to listen to the music. Instructions for obtaining the proper authorization are also preferably included in the message. For example, an audio tag stating “please go to the following web address to purchase access rights for this file” may be played. Thus, the instructions might include accessing a web site and paying for the privilege of listening. Preferably, payment is not only a one time payment, but also may be for differing levels of access to the music file, as will be explained in more detail below.

As stated, the encrypted content 5522 includes all of the audio frames necessary to play the MP3 file. This encrypted data also includes DRM data including trial and purchased play rights and public keys associated with differing levels of access, namely, “trial”, “play” and “song”. The “trial” level access permits the user is permitted to listen to the song/track once, or within a date/time window, and thereafter is precluded from listening without again obtaining the proper authorization. The “play” level access permits the user to play the song/track a predetermined number of times, e.g., five times. After the fifth play, the song/track remains encrypted until the user obtains the appropriate authorization by, for example, paying for such additional use. Finally, the “song” level access permits the user to buy the song/track whereby the user can have unlimited access to the song or track.

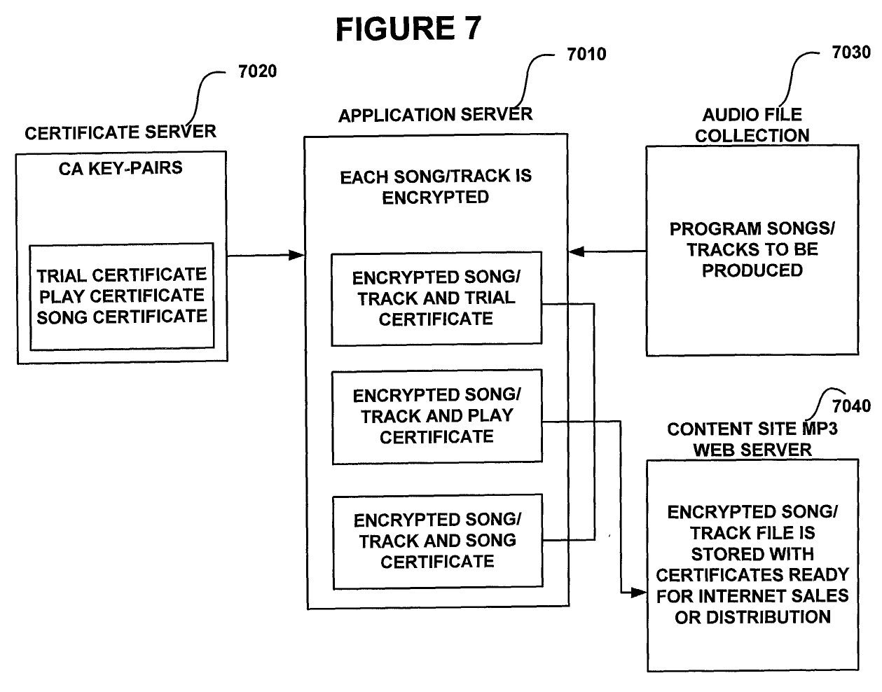

The modified MP3 file layout or format 5500 of FIG. 6 is preferably generated by the process depicted in FIG. 7. An application server 7010 is in communication with a certificate server 7020 and an audio file collection 7030. The certificate server 7020 provides any CA key-pairs and certificate with the differing levels of access contemplated by the present invention. The audio file collection 7030 includes unencrypted songs and tracks that are desired to be encrypted before being release to the public. Encrypted content is “de-synchronized” so that non-PKI-enabled players will not mistake the encrypted content for real audio data. Thus, a “header” portion of the encrypted MP3, or any other format, format is 100% compatible with the existing unencrypted version of the format.

This, as shown, the application server 7010 receives each song/track from the audio file collection 7030, encrypts it using the provided key-pairs and attaches the three certificates corresponding to the three possible level of access from the certificate server 7020. (Of course, the three levels of the access described are exemplary only and other types of controlled access can be implemented using the same principles discussed herein.) The encrypted song/track is depicted as being wrapped in a ring in the application server 7010. Each encrypted song/track is then transferred, preferably via SSL connection for added security, to a content web site 7040 that serves up MP3 files in the conventional manner. Thus, encrypted songs/tracks are stored with certificates and are ready for sales or distribution via the Internet.

Thus, in accordance with the present invention, “intelligent” DRM digital certificates (trial, play and song certificates) are generated each time a song is encrypted, with multiple certificate generated per song depending on the number of rights sets desired, to encrypted and permanently bind customer identify at time of encryption, billing and other information including origin and trial policy to the file for both online and offline access control. Additionally, a trial portion of the content can be encrypted with the trial key, while the remaining portion of the content is encrypted using a play or song key. The MP3 files are encrypted using PKI digital certificates, whereby maximum security is ensured. Further, content is secured for direct download from the content site and secure payment authorization is available from the content site. Finally, permanent file tracking is provided such that online and office audit trials and intelligent certificate data tracking is available. Offline audit trails are supplied in a digitally scrambled machine-specific “log” file (e.g., GUID-based) denoting the history of access to the content per machine or site, and digitally signed and authenticated by the local agent to prevent alternation. The log file may also be used to track usage and demographic data for periodic upload to a content provider, or with the local agent facilitate renewal of any advertising that may optionally be embedded into the original content, and overlay or “refresh” such content as appropriate. This advertising may, or may not, be in the same format as the content.

To play the thus-encrypted songs/tracks, an MP3 player preferably includes a local agent similar to that described previously with respect to the electronic messaging embodiment of the present invention. Thus is, the MP3 player, computer, or other streaming content platform (e.g., intranets, extranets, or the internet) onto which MP3 files are downloaded preferably includes a local agent that is able to decrypt encrypted audio files in accordance with the present invention, directly into the application or codec, all with limited or no user intervention.

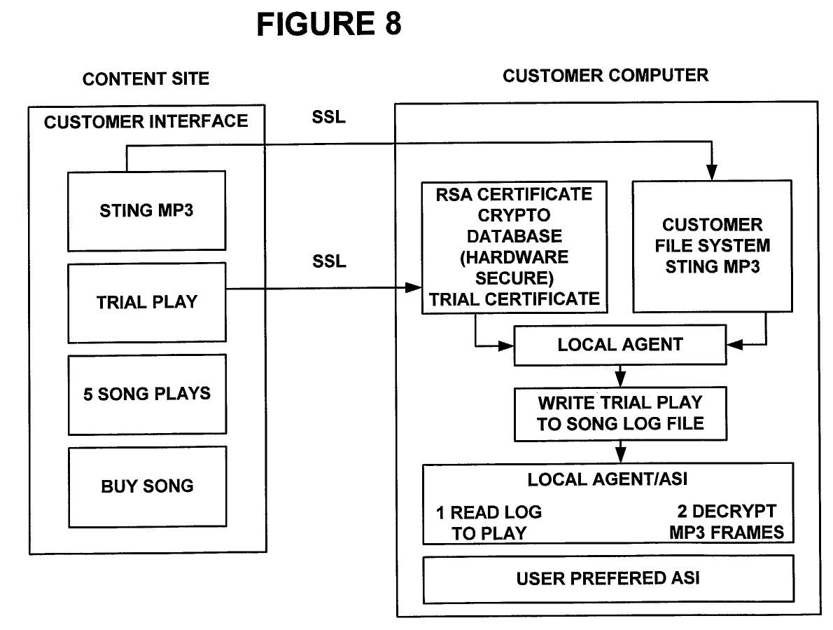

In some cases, however, the local agent may be appended to the content itself. More specifically and with the reference to FIGS. 8-10, the unlocking or decryption process commences according to validation rules for purchase and/or trial access rights and the DRM certificate type. Preferably, “trial” play is used as a default if no “log” history is denoted. Customer and file profile data is validated utilizing public private key matching algorithms. Once authorization is secured to play the file using an MP3 player, the MP3 file is decrypted frame by frame from, e.g., a personal computer hard drive. That is, the local agent decrypts the frames using the appropriate key pairs in conjunction with the applicable certificate.

Referring to FIG. 8, the content site 7040 (which is the same as that shown in FIG. 7), upon request and/or payment, sends to a customer's computer 100 the encrypted MP3 file (“Sting MP3”) and, in this case, a trial play certificate. The private key(s) unlocked from the digital certificate are downloaded to the user's local machine, and used to determine what rights set the user has access to. The certificate is used to identify the rights set and match to the public key (or certificate) encoded in the song to the private key. Thus, all public keys (trial or play) are present in the song. Any matching private keys are preferably sent via SSL connection for added security, except the trial key that is preferably attached to the content. When the customer attempts to play the song, the MP3 file and available certificate(s) are identified by the local agent (that has been dynamically or previously installed in the customer's computer). The local agent, upon ascertaining that the certificate is for trial play only, writes to a song log file (which is not accessible by the customer) that the song is for trial play only, i.e., single use. The local agent thereafter reads the log file to determine if there are any further plays remaining in the song log file and, if so, decrypts the MP3 file frame by frame and passes the data to the customer's player.

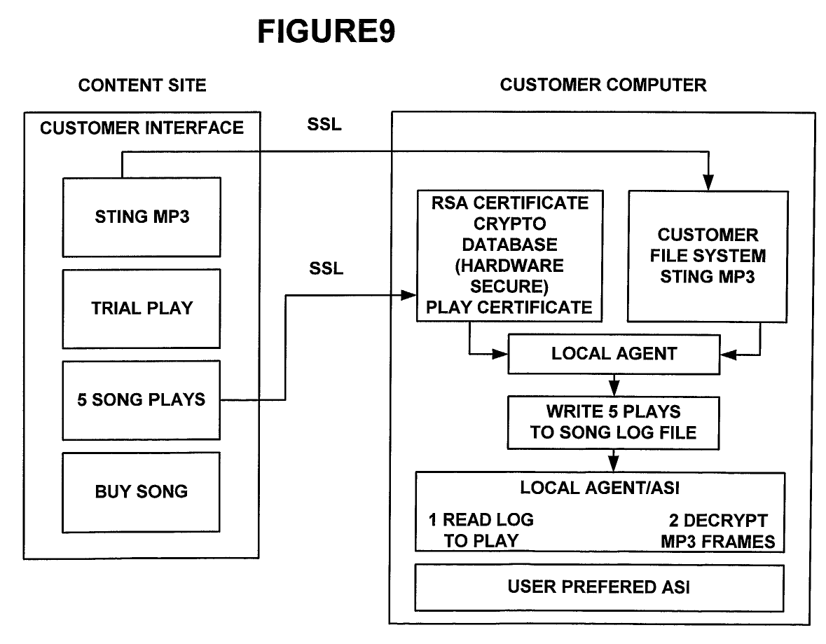

FIG. 9 is essentially identical to FIG. 8, except that in this case, a play certificate or key is provided by the content site. Here, the certificate indicates that the song can be played five times. When a user purchases the rights to a song, an appropriate play key is downloaded (and a certificate to cross-reference that private key). Accordingly, the local agent writes to the song log file that five playing of the song are permitted. Each time the song is played, the local agent increments or decrements a count in the song log file, so that the next time the customer attempts to play the song the local agent will know if the customer is entitled to further playing. The agent may optionally synchronize the local log file to the site of the original content provider or distributor.

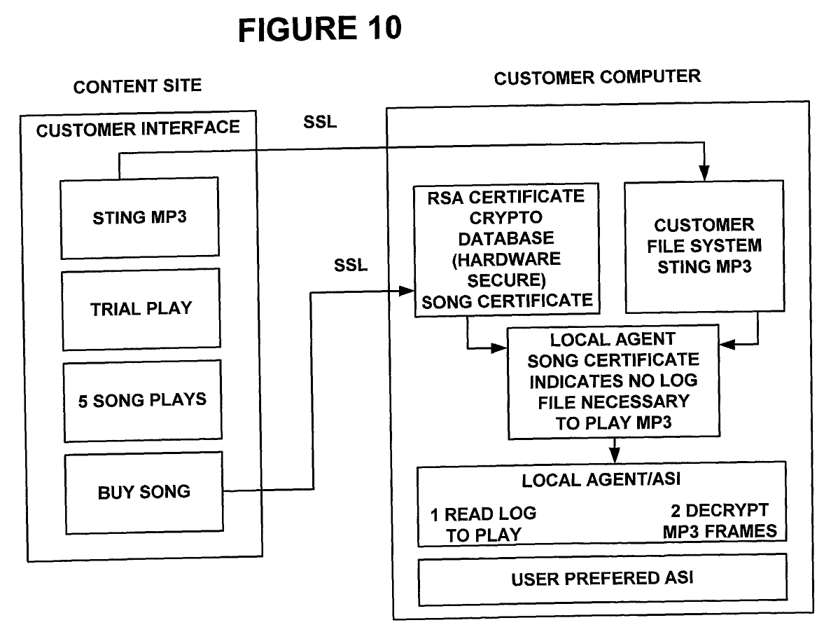

FIG. 10 is similar to the process illustrated in FIGS. 8 and 9 except in this case the customer buys the song and is therefore entitled to play it as many times as he wishes. Accordingly, there is no need to check a song log file prior to decryption.

Two-Factor Authentication

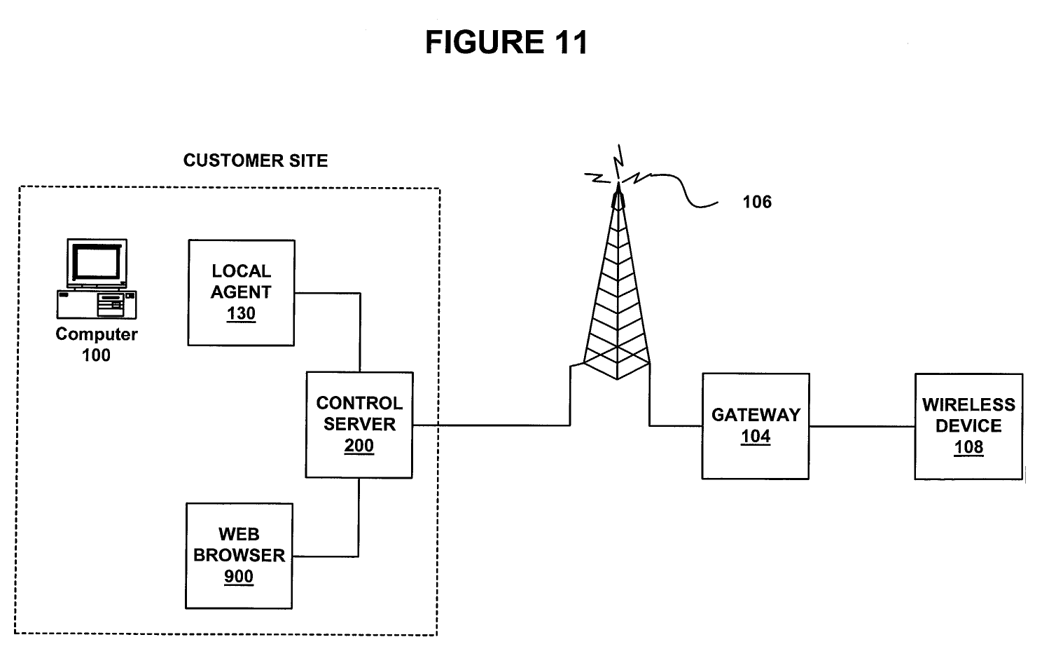

FIG. 11 is a block diagram illustrating an exemplary embodiment of the wireless trust system of the present invention. The sender electronic device 100 is, but is not limited to, a computer that is coupled to recipient wireless device 102, such as a cell phone or wireless personal digital assistant (PDA), via a control server 200. Control server 200 is connected to web browser 900.

The gateway 104 is coupled via a wireless link to a recipient wireless device 108. Wireless communication system 106 is coupled to gateway 104. A wireless device 108, such as, a cell phone is to a wireless communication system 106.

The wireless communication system 106 is capable of transmitting and receiving wireless communication signals. For example, they may be standard cellular towers having cellular communications.

The gateway 104 includes processes, which route communications to and from the wireless device 108, built in with two-factor authentication technology to secure access to data, applications and other resources residing on the Internet.

Electronic device 100 includes a messaging application 110 (as shown in FIG. 1), such as, but not limited to, LOTUS NOTES OR MICROSOFT OUTLOOK allow the users to send, forward launch, and view content such as, but not limited to, an email, an email attachment, a streaming media file, or an XML file.

Also loaded on electronic device 100 is a local agent 130 that communicates with the messaging application via an ASI agent 120 (as shown in FIG. 1).

Electronic device 100 associated with sender local agent transmitted an encrypted content package via an electronic network, such as, but not limited to, the Internet, to the control server 200. The control server 200 then obtains a public key associated with the recipient at wireless device 108 from the sender electronic device 100.

The control server 200 requests a certificate from PKI server 400 who then retrieves the sender's signing and encrypted key in order to generate a certificate authority (CA). Once the above process is authenticated, secured and confirmed, the control server 200 transmits the encrypted content package to the recipient at wireless device 108 via the gateway 104.

The wireless device 108 associated with the two-factor authentication will prompt the recipient to enter a user password or personal identification number (PIN) and generate a one-time passcode at a predetermined interval, such as, every 60-seconds, to the recipient at wireless device 108. Once the authentication process is completed, the recipient will then be allow to access the network.

Thus, as is evident from the foregoing, the present invention provides systems and methods to automatically implement robust PKI-based encryption with respect to messaging applications, browsers, presentment services and digital right management (DRM), and all with virtually no user intervention.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams. In addition, protocols of various types are references throughout. While preferred and alternate embodiments may implement selected protocols, any suitable replacement protocol not mentioned, or any function not part of a protocol used to replace a corresponding function from a protocol may be implemented without departing from the scope of the invention. While various elements of the preferred embodiments have been described as being implemented in software, in other embodiments hardware or firmware implementations may alternatively be used, and vice-versa.

The claims should be not read as limited to the described order or elements unless states to that effect. Therefore, all embodiments that come within the scope and spirit of the following claims and equivalents thereto are claimed as the invention.

What is claimed is:

1. A system for implementing public key infrastructure (PKI) based encryption of content between a sender and a recipient, the system comprising:
a sender local agent associated with a sender electronic device, the sender electronic device being capable of connection to the Internet;
a recipient two-factor authentication associated with a recipient device, the recipient device being capable of connection to the Internet;
a wireless communication system that receives and transmits full-duplex wireless signal to and from the recipient; and
a control server, the control server capable of being in communication with both the sender local agent and the recipient two-factor authentication;
the sender local agent being operable to (i) receive content generated on the sender electronic device, (ii) generate a package of encrypted content using PKI-based encryption by obtaining at least one public key from one of the control server and a local registry, and (iii) send the package to the control server;
the control server being operable to receive the package from the sender local agent and transmit the package to the recipient two-factor authentication; and
the recipient two-factor authentication being operable to (i) receive the package from the sender local agent, (ii) prompt the recipient to enter a user PIN, (iii) responsive to receiving the user PIN, generate a one-time passcode that is valid within a predetermined interval, and (iv) allow the recipient to access the network within the predetermined interval using both the user PIN and the one-time passcode.

2. The system of claim 1, wherein the device is a wireless device.

3. The system of claim 1, wherein the electronic device is a network device.

4. The system of claim 1, wherein the wireless communication system is connected to the gateway.

5. The system of claim 1, wherein the control server is connected to the Internet.

6. The system of claim 1, wherein the control server is operable to communicate with a local agent that is associated with a electronic device which itself is accessible via the electronic network.

7. The system of claim 1, wherein the local agent is operable to the automatically obtain the public key via a control server in communication with the electronic network.

8. The system of claim 1, wherein the web browser is operable to offer a level of security via Secure Socket Layer (SSL) connection.

9. A method of automatically implementing PKI-based encryption between a sender and a recipient, the method comprising the steps of:
associating a sender local agent with a sender electronic device, the sender electronic device being capable of connection to the Internet;
associating a recipient two-factor authentication with a recipient wireless device, the recipient wireless device being capable of connection to the Internet;
providing a control server, the control server capable of being in communication with both the sender local agent and recipient two-factor authentication;
receiving by the sender local agent, content generated on the sender electronic device;
generating by the sender local agent, a package of encrypted content using PKI-based encrypted by obtaining a least one public key from one of the control server and a local register;
send the package to the control server;
receiving the package at the control server;
receiving by the recipient two-factor authentication, the package from the control server;
requesting a user PIN;
responsive to receiving the user PIN, generate a one-time passcode that is valid within a predetermined interval; and
accessing to the network within the predetermined interval using both the user PIN and the one-time passcode.

10. A computer readable medium having stored herein instructions for causing central process unit to execute the method of claim 9.

11. The method of claim 9, wherein the content is at least one of an email message, an email attachment, a document, a business transaction, a medical record, a graphic and steaming audio or video.
